(19) United States
(12) Patent Application Publication
(10) Pub. No.: US 2018/0077021 A1
(43) Pub. Date: Mar. 15, 2018

(54) Selective Network Sleep and Wake

(71) Applicant: Apple Inc., Cupertino, CA (US)

(72) Inventors: Koussalya Balasubramanian, Santa Clara, CA (US); Robert B. Boatright, Los Gatos, CA (US); Kevin J. White, Los Gatos, CA (US)

(21) Appl. No.: 15/695,302

(22) Filed: Sep. 5, 2017

Related U.S. Application Data
(60) Provisional application No. 62/394,415, filed on Sep. 14, 2016.

(51) Int. Cl. H04L 12/24

(52) U.S. Cl. CPC H04L 41/0836; H04L 41/32; H04L 41/0813

(57) ABSTRACT

A network switch having a plurality of ports may be configured with a plurality of wake domains, which may be independently transitioned between at least a wake state and a sleep state. For example, one or more wake domains may transition between a wake state and a sleep state while one or more other wake domains do not change state. The ports included in each of the wake domains may be dynamically configurable. In this way, power may be conserved by operating a subset of the plurality of ports in the wake state, while other ports remain in the sleep state. In some embodiments, the wake domains may be prioritized, such that, upon a simultaneous command, a higher-priority wake domain may be awakened before a lower-priority wake domain. In this way, high-priority ports may be awakened in less time than would be required to awaken the entire network switch.

### PRIORITY INFORMATION

This application claims priority to U.S. provisional patent application Ser. No. 62/394,415, titled “Selective Network Sleep and Wake,” by Koussalya Balasubramanian, et al., filed Sep. 14, 2016, which is hereby incorporated by reference in its entirety as though fully and completely set forth herein.

### FIELD

The present disclosure relates to network communication, including to techniques for selectively controlling states of subsets of a multi-port system, such as a network switch.

### DESCRIPTION OF THE RELATED ART

A network (e.g. Ethernet Local Area Network) may include one or more multiport network hubs, such as switches or routers, along with a plurality of end points. Multi-port switches often are power hungry due to the number of ports, configuration to support the ports (switching table etc.,) and several specialized protocols (e.g. filtering, queue management) running on top of the base switching fabric. In at least certain applications, the switch can be idle for a considerable amount of time (e.g., at night time when internet traffic is low, or after work hours in industrial systems). Having the switch powered on even when it is not actively switching traffic leads to power waste.

Some applications are also sensitive to how fast the network can restore from a power-down state. For example, when a user interaction triggers restoration from a power-down state, a noticeable delay in the restoration may negatively impact the user experience.

In other words, there are conflicting requirements between reducing power consumption and reducing wake times, e.g., for real-time applications. Therefore, improvements in this area are desirable.

### SUMMARY

In light of the foregoing and other concerns, some embodiments relate to a network switch configured with a plurality of wake domains, which may be independently transitioned between a wake state and a sleep state.

For example, a network switch is disclosed, which may include a plurality of ports, a first wake domain including a first subset of the plurality of ports and a first portion of a switch fabric, and a second wake domain including a second subset of the plurality of ports and a second portion of the switch fabric. The first wake domain and the second wake domain may be configured to independently transition between a lower-power state and a higher-power state (or low-power and high-power states).

In some embodiments, the network switch may further include management circuitry configured to dynamically add one or more ports of the plurality of ports to either of the first subset of the plurality of ports and the second subset of the plurality of ports, and to dynamically remove one or more ports from either of the first subset of the plurality of ports and the second subset of the plurality of ports.

In some embodiments, the network switch may further include at least one power gate configured to selectively block power to at least a portion of the first wake domain to cause the first wake domain to transition to the low-power state. The network switch may further include at least one power gate configured to selectively block power to at least a portion of the second wake domain to cause the second wake domain to transition to the low-power state, wherein the selectively blocking power to at least a portion of the second wake domain is independent of the selectively blocking power to at least a portion of the first wake domain.

In some embodiments, the first wake domain may be configured to transition from the high-power state to the low-power state at least in part by blocking power to the first set of ports.

In some embodiments, the first portion of the switch fabric may include a first set of buffers associated with the first set of ports. The first wake domain may be configured to transition from the high-power state to the low-power state at least in part by blocking power to the first set of buffers.

In some embodiments, the switch fabric may include a memory. The first wake domain may be configured to transition from the low-power state to the high-power state at least in part by saving to the memory a first portion of a switching table, the first portion of the switching table defining routing between the first subset of ports. The first portion of the switching table may not define routing between the first subset of ports and other ports of the network switch that are in the low-power state. In some embodiments, the first portion of the switching table may further define routing between the first subset of ports and other ports of the network switch that are in the high-power state.

In some embodiments, the network switch may further include a third wake domain including a third subset of the plurality of ports and a third portion of the switch fabric. The third wake domain may be configured to transition between a low-power state and a high-power state independently of the first wake domain and the second wake domain.

In some embodiments, the second wake domain may be configured to transition from the low-power state to the high-power state at least in part in response to the network switch detecting energy on a specified port of the first wake domain while the first wake domain is in the high-power state. The network switch may further include management circuitry configured to dynamically specify the specified port of the first wake domain.

A method of operating a network switch having a plurality of ports is disclosed. The method includes configuring the network switch such that the plurality of ports is in a sleep state, wherein a port in the sleep state is not configured to transmit or receive signal traffic; and transitioning a first subset of the plurality of ports from the sleep state to a wake state while a second subset of the plurality of ports remains in the sleep state, wherein a port in the wake state is configured to transmit or receive signal traffic.

In some embodiments, the method may further include configuring the network switch such that the plurality of ports are in the wake state. Configuring the network switch such that the plurality of ports are in the sleep state may be at least partly in response to inactivity on the plurality of ports for a threshold period of time following the configuring the network switch such that the plurality of ports are in the wake state.

In some embodiments, the method may further include detecting energy at a first port of the first subset of the plurality of ports while the first subset of the plurality of ports is in the wake state; and, in response to detecting the energy at the first port, transitioning the second subset of the plurality of ports from the sleep state to the wake state.

In some embodiments, the method may further include receiving configuration information specifying the first port as a trigger port for waking the second subset of the plurality of the ports. Transitioning the second subset of the plurality of ports from the sleep state to the wake state may be further in response to determining that the first port has been specified as the trigger port.

In some embodiments, the method may further include automatically transitioning the second subset of the plurality of ports from the sleep state to a wake state in response to determining that the first plurality of ports has completed transitioning from the sleep state to the wake state. In some embodiments, the method may further include receiving configuration information specifying that the first subset of the plurality of ports is a higher-priority subset than the second subset of the plurality of ports; and receiving an instruction to wake the network switch. Transitioning the first subset of the plurality of ports from the sleep state to a wake state, while a second subset of the plurality of ports remains in the sleep state, may be in response to receiving the instruction to wake the network switch and may be further in response to determining that the first subset of the plurality of ports is a higher-priority subset than the second subset of the plurality of ports.

In some embodiments, the method may further include receiving configuration information specifying ports to be included in the first subset of the plurality of ports and ports to be included in the second subset of the plurality of ports.

In some embodiments, transitioning the first subset of the plurality of ports from the sleep state to the wake state while the second subset of the plurality of ports remains in the sleep state may include configuring at least one power gate to provide power to the first subset of the plurality of ports without providing power to the second subset of the plurality of ports.

In some embodiments, transitioning the first subset of the plurality of ports from the sleep state to the wake state while the second subset of the plurality of ports remains in the sleep state may include configuring a first portion of a switch fabric of the network switch, the first portion of the switch fabric providing routing between the first subset of the plurality of ports and not providing routing between the second subset of the plurality of ports.

This summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of the preferred embodiment is considered in conjunction with the following drawings, in which:

FIG. 1 illustrates an exemplary (and simplified) network communication system, according to some embodiments;

FIG. 2 illustrates an exemplary network switch, according to some embodiments;

FIG. 3 illustrates a block diagram of an exemplary network switch having multiple wake domains, according to some embodiments;

FIGS. 4-5 are flow charts illustrating exemplary methods of operating a network switch having a plurality of ports, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Terms

The following is a glossary of terms used in the present disclosure:

Memory Medium—Any of various types of non-transitory computer accessible memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory media which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—any of various hardware devices including multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic.”

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

Base Station or Access Point (AP)—The term “Base Station” has the full breadth of its ordinary meaning, and at least includes a wireless communication station installed at a fixed location and used to communicate as part of a wireless telephone system or radio system.

Processing Element—refers to various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

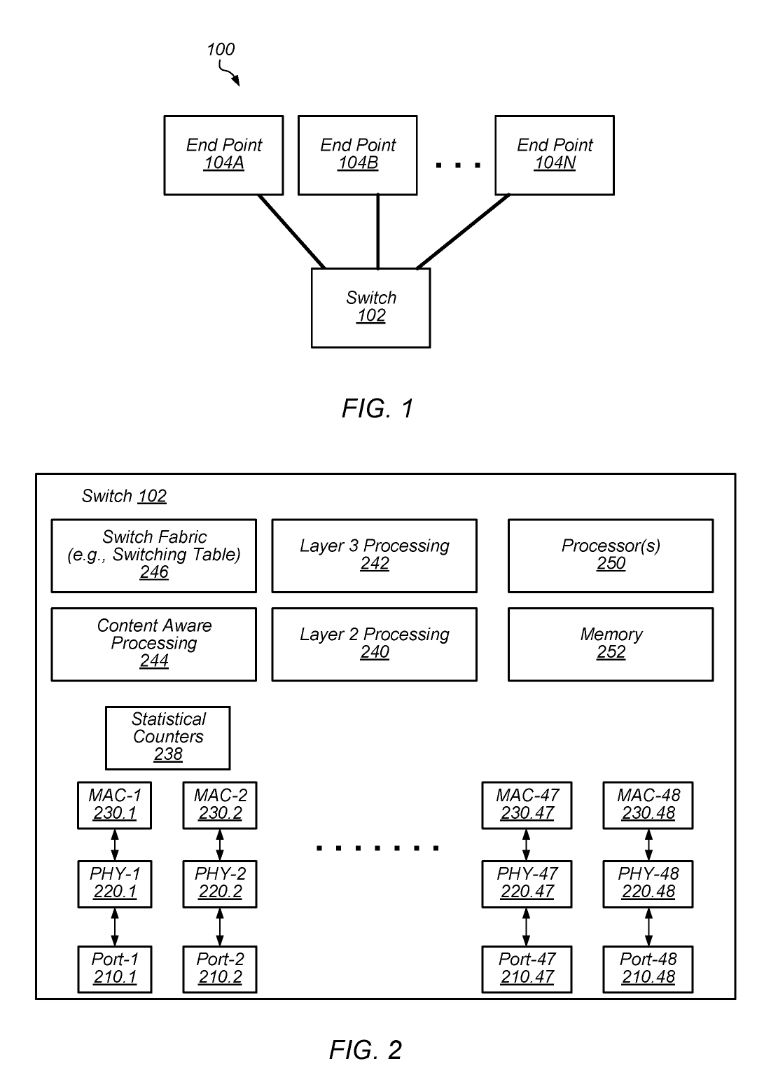

### FIG. 1—Communication Network

FIG. 1 illustrates an exemplary (and simplified) communication network 100, according to some embodiments. It is noted that the network 100 of FIG. 1 is merely one example of a possible network, and embodiments may be implemented in any of various networks, as desired. For example, note that although the exemplary communication network 100 illustrated in FIG. 1 is shown as including three end points, aspects of the disclosure may be implemented in communication networks having greater or lesser numbers (i.e., any number) of end points. The communication network 100 may be implemented in a variety of settings (e.g., office, home, industrial facility, mobile platform), using any of a variety of communication technologies (e.g., Ethernet, Fibre Channel, Asynchronous Transfer Mode (ATM), InfiniBand).

As shown, the exemplary communication network 100 includes a switch 102 in communication with endpoints 104A-104N over a transmission medium. The switch 102 may connect the end points 104 by receiving, at a first port, a communication from a source end point (e.g., 104A), processing the communication, and forwarding the communication to a destination end point (e.g., 104B), via a second port. It should be understood that, although the switch 102 is referred to herein as a “switch,” this is not intended to be limiting, and any multiport hub may be used wherever a switch is referenced throughout this specification, if configured to operate according to the techniques described herein.

Each of the end points 104 may include (or be implemented as) any of a variety of computing devices, input devices, output devices, and/or communication devices. For example, an end point 104A may include a wired or wireless modem, to allow another endpoint (e.g., 104B) in the communication network 100 to communicate with a remote network, such as the Internet, via the endpoint 104A. As another example, an end point 104A may include a wireless communication device configured to allow another endpoint (e.g., 104B) in the communication network 100 to communicate, via the endpoint 104A, with remote wireless communication devices via various wireless communication technologies, such as Wi-Fi, Bluetooth, or various cellular technologies (GSM, UMTS, LTE, LTE-Advanced, CDMA, W-CDMA, etc.). As a specific example of such a wireless communication device, an end point 104A may include a Wi-Fi access point. As other examples, the end points 104 may include any of a variety of computers, printers, scanners, sensors, actuators, controllers, home automation equipment, media devices, game consoles, cameras, or any other devices configured to communicate within the communication network 100.

The switch 102 may be configured to perform any of the method embodiments described herein, or any portion of any of the method embodiments described herein. Specifically, the switch 102 may include hardware and/or software components for implementation as a multiple wake domain switch, as further described below.

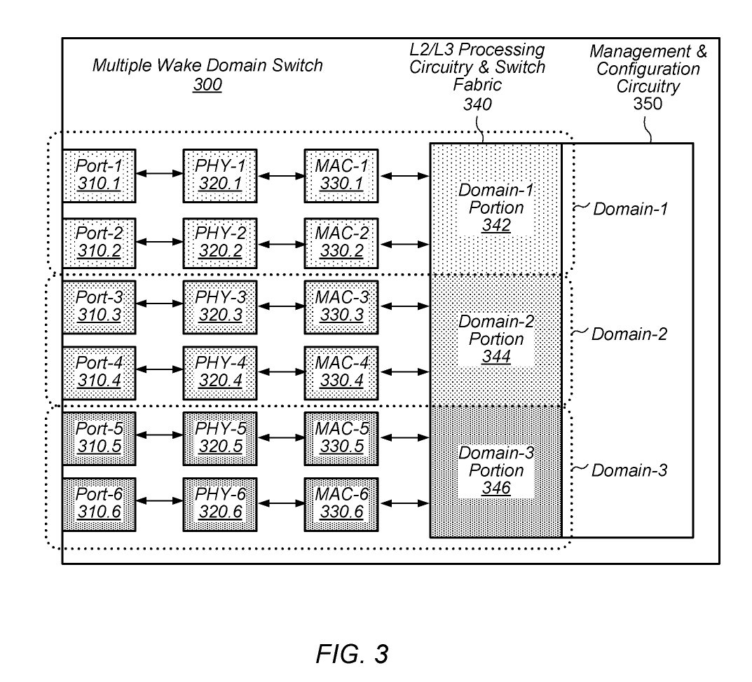

### FIG. 2—Exemplary Block Diagram of a Switch

FIG. 2 illustrates an exemplary high-level block diagram of the switch 102, which may be configured for use in conjunction with various aspects of the present disclosure, according to some embodiments.

As shown, the switch 102 may include a plurality of ports 210. Although FIG. 2 represents the switch 102 as having 48 ports, this is merely exemplary; the switch 102 may have a greater or lesser number (any number) of ports. One or more of the ports 210.1-210.48 may be connected, via a transmission medium, to a respective end point, e.g., an endpoint 104. Any/all of ports 210 may include a physical connection or coupling to a transmission medium.

As shown in FIG. 2, the ports 210.1-210.48 may be communicatively coupled to a respective physical layer (PHY) module 220.1-220.48. Any/all of the PHY modules 220.1-220.48 may perform physical layer processing on incoming and outgoing communications passing through the associated port, e.g., modulation/demodulation, line coding, forward error correction, etc. In some embodiments, the ports 210 may be considered to be included within the respective PHY modules 220. PHY modules 220 may include a processing element such as one or more of a processor, an ASIC (application specific integrated circuit), an FPGA (field-programmable gate array), or some combination thereof In some embodiments, PHY modules 220 may include a software module to be executed on the processing element for performing physical layer processing of signals. In some embodiments, two or more of the PHY modules 220.1-220.48 may share one or more components, such as a processing element and/or a software module.

As shown in FIG. 2, any/all of the PHY modules 220.1-220.48 may be communicatively coupled (directly or indirectly) to a respective media access control layer (MAC) module 230.1-230.48. Any/all of the MAC modules 230.1-230.48 may perform MAC processing on incoming and outgoing communications passing through the associated port, e.g., frame delimiting and recognition, addressing, access control to the transmission medium, etc. In some embodiments, MAC module 230 may include a processing element such as one or more of a processor, an ASIC, an FPGA, or some combination thereof. In some embodiments, any/all of the MAC modules 230 may include a software module to be executed on the processing element for performing MAC processing of signals. In some embodiments, two or more of the MAC modules 230.1-230.48 may share one or more components, such as a processing element and/or a software module.

As shown in FIG. 2, the switch 102 may further include additional modules, such as any/all of statistical counters 238, for tracking statistics such as packet throughput and collisions; layer 2 processing module 240, for performing additional layer 2 processing, such as logical link control; layer 3 processing module 242, for performing layer 3 processing, such as packet forwarding; content aware processing module 244, for performing processing such as filtering and classification; and switch fabric 246. The switch 102 may also include memory 252 and one or more processor(s) 250, which may be configured to execute software stored on the memory 252, e.g., to implement software portions of the modules 238-246. For example, the switch fabric 246 may include a switching table, which may be stored in the memory 252 and implemented by the processor(s) 250. Any of the modules 238-246 may further include general, specialized, and/or dedicated hardware configured to facilitate the functions of the specific module, such as processors, buffers, counters, switches, power gates, clock gates, dedicated memory, etc.

The switch 102 may additionally include any of a variety of other components (not shown) for implementing switch functionality, depending on the intended functionality of the switch 102, which may include further processing and/or memory elements, one or more power supply elements (which may rely on battery power and/or an external power source), user interface elements, additional communication elements, and/or any of various other components.

The components of the switch 102, such as the modules 238-246, the processor(s) 250, the memory 252, and the MAC modules 230.1-230.48, may be operatively coupled via one or more intra-chip or inter-chip interconnection interfaces, which may include any of a variety of types of interface, possibly including a combination of multiple types of interface.

The switch 102 may include hardware and/or software components for implementation as a multiple wake domain switch, as further described below.

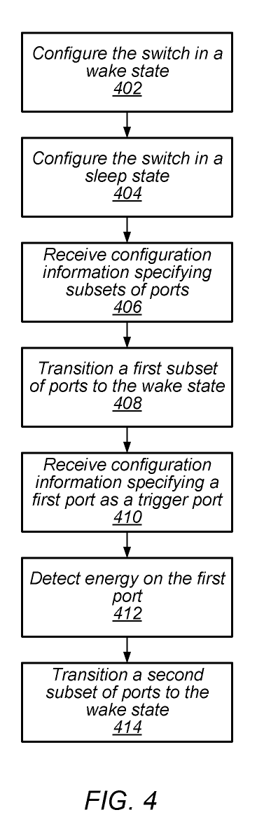

### FIG. 3—Exemplary Block Diagram of a Multiple Wake Domain Switch

FIG. 3 illustrates an exemplary block diagram showing, in greater detail, selected portions of a switch 300 having multiple wake domains, according to some embodiments. The switch 300 may represent some embodiments of the switch 102.

As shown, the switch 300 may include a plurality of ports 310, which may be similar to the ports 210 of FIG. 2. Although FIG. 3 represents the switch 300 as having 6 ports, this is merely exemplary; the switch 300 may have a greater or lesser number (any number) of ports.

As shown in FIG. 3, any/all of the ports 310.1-310.6 may be communicatively coupled to a respective PHY module 320.1-320.6, which may be similar to the PHY modules 220 of FIG. 2. In some embodiments, the ports 310 may be considered to be included within the respective PHY modules 320.

As shown in FIG. 3, the PHY modules 320.1-320.6 may be communicatively coupled to a respective MAC module 330.1-330.6, which may be similar to the MAC modules 230 of FIG. 2.

As shown in FIG. 3, the MAC modules 330 may be communicatively coupled to switch fabric 340, which may also include circuitry for performing L2/L3 processing. The switch fabric 340 may be configured to dynamically route signals from a first (input) port to a second (output) port. For example, the switch fabric 340 may include a switching table (e.g., maintained in a memory and/or processing circuitry included in or in communication with the switch fabric 340) specifying a routing configuration between ports, as well as physical routing hardware (e.g., crossbar matrix, backplane), storage buffers, etc. to implement the routing defined by the switching table.

As shown in FIG. 3, the switch fabric 340 may be communicatively coupled to management and configuration circuitry 350, which may be configured to manage and configure the switch fabric 340.

As shown in FIG. 3, at least the signal processing and switching portions of the switch 300 may be divided into a plurality of wake domains, such as domain-1, domain-2, and domain-3. Each wake domain may include a portion of the switch fabric 340. For example, as illustrated in FIG. 3, domain-1 includes a portion 342 of the switch fabric 340, domain-2 includes a portion 344 of the switch fabric 340, and domain-3 includes a portion 346 of the switch fabric 340. Each wake domain may further include one or more port(s), with associated PHY module(s) and MAC module(s). For example, as shown in FIG. 3, domain-1 includes port-1 310.1 and port-2 310.2 and their associated processing chains (e.g., PHY-1 320.1, MAC-1 330.1, PHY-2 320.2, and MAC-2 330.2), domain-2 includes port-3 310.3 and port-4 310.4 and their associated processing chains, and domain-3 includes port-5 310.5 and port-6 310.6 and their associated processing chains. Although FIG. 3 represents the switch 300 as having 3 domains, this is merely exemplary; the switch 300 may have as few as two domains, or may include a larger number of domains, at least up to the number of ports included in the switch 300. In some embodiments, the switch 300 may include more domains than the number of ports included in the switch, e.g., where some ports belong to more than one domain. Further, while FIG. 3 shows two ports associated with each domain, the number of associated ports can vary across domains and a port can be assigned to more than one domain.

Each wake domain within the switch 300 may be placed in at least a low-power (e.g., sleep) state or a high-power (e.g., wake) state, independent of the other wake domains. In some embodiments, the low-power state may be a powered-off state. In some embodiments, there can be one or more additional intermediate reduced-power states (e.g., a trigger state) into which a wake domain can be placed.

For example, in some embodiments, the switch 300 may include a network of power gates and/or clock gates connected to some or all of the components included in wake domains. A wake domain may be placed in a low-power state by removing power and/or clock signals from some or all of the hardware included in the wake domain, e.g., by configuring one or more power gate(s) and/or one or more clock gate(s) supplying such hardware to block power and/or clock signal(s). The wake domain may be placed in a high-power state by restoring the power and/or clock signals, e.g., by reconfiguring the one or more power gate(s) and/or one or more clock gate(s). For example, one or more power gates may be configured to selectively block power to at least a portion of a first wake domain (e.g., at least a subset of hardware included within or assigned to the first wake domain) to cause the first wake domain to transition to the low-power state, e.g., without affecting power supply to portions of the switch outside the first wake domain. As a specific example, domain-1 as illustrated in FIG. 3 may be placed in a low-power state by removing power and/or clock signals from one or more (e.g., all) of port-1 310.1, PHY-1 320.1, MAC-1 330.1, port-2 310.2, PHY-2 320.2, MAC-2 330.2, and portion 342 of the switch fabric 340 (such as signal buffers). Placing domain-1 in a high-power state may include restoring power and/or clock signals to these components (as applicable). In this specific example, changing the state of domain-1 may not include affecting the power or clock signals to either/both of domain-2 and domain-3.

In some embodiments, a routing table of the switch fabric 340 may be stored in memory (e.g. outside of the switch fabric 340), and may be loaded by the switch fabric 340 (e.g., loaded in a memory of the switch fabric 340) when the switch 300 is active (e.g., powered on). Therefore, placing a wake domain in high-power state may additionally, or alternatively, include loading portions of the routing table usable by the portion of the switch fabric 340 within the wake domain. Some or all of the portions of the routing table that are not usable by the portion of the switch fabric 340 within the wake domain may not be loaded. Placing the wake domain in a low-power state may include powering down buffers (or other memory elements) that are used for routing signal traffic to/from the ports of the wake domain, e.g., by configuring one or more power gates and/or one or more clock gates. Reducing the portion of the switch fabric that is active (e.g., loaded, powered) may provide substantial power savings, as the switch fabric may often be the portion that consumes the most power during operation (e.g., the most power-hungry portion of a switch). Additionally, reducing the portion of the routing table that must be loaded when transitioning to a high-power state may provide time savings.

As a specific example, if all three domains as illustrated in FIG. 3 are initially in a low-power state, then transitioning domain-1 to a high-power state may include loading into the switch fabric 340 portions of the routing table defining routing between port-1 310.1 and port-2 310.2 (the ports included in domain-1). Portions of the routing table defining routing to other ports may not be loaded by the switch fabric 340, because those ports remain in a low-power state in domain-2 and/or domain-3. Subsequently transitioning domain-2 into a high-power state, while domain-1 remains in a high-power state, may include loading into the switch fabric 340 portions of the routing table defining routing between any of port-1 310.1, port-2 310.2, port-3 310.3, and port-4 310.4 (or portions thereof not previously loaded while transitioning domain-1 to a high-power state). Portions of the routing table defining routing to/from ports 5-6 may not be loaded by the switch fabric 340, because those ports remain in a low-power state in domain-3.

In a traditional (i.e., single wake domain) switch, power may be saved by putting the entire switch into a sleep mode. Similarly, when any port needs to be awakened, the whole system (e.g., all the ports, MAC modules, and switch fabric) is awakened. Waking the entire system in this manner may require a significant amount of time. For example, a typical off-the-shelf 48-port switch may take hundreds of milliseconds to wake from sleep. Thus, if a quick response-time is important for a given use case, that use case may dictate that a traditional switch remain continually in the wake state. However, this may incur significant power cost. For example, a typical off-the-shelf 48-port switch today may consume tens of watts when all ports are active.

By contrast, the multiple wake domain switch of FIG. 3 allows dividing the switch into a plurality of wake domains, and may further support configurable priorities and actions for selected domains, as further discussed below.

### Dynamic Configuration

When the switch is idle, all ports and the switching fabric may be placed in a low-power state. In some scenarios, certain logic may remain active to monitor for a wake trigger, which could be received in various ways. For example, a wake trigger may be generated by a processor, such as a CPU (internal or external to the switch), or by presence of electrical energy on a port (also known as energy detect). Upon receiving a wake trigger, an internal configuration may define the ports that should be awakened in response to that particular trigger. In this way, different wake triggers may cause different results.

Table 1 illustrates an example of a “wake map”—a configuration table defining sets of ports to be awakened in response to detecting energy on one of six ports of a multiple wake domain switch, such as the switch 300 of FIG. 3. In the example of Table 1, the switch may include six wake domains, each including one port. Thus, each port may be awakened individually. In some implementations, any number of wake domains may be defined, involving any number/combination of ports to be awakened in response to any number of different triggers.

TABLE 1
Wake Map

Ports to Wake

| | | 1 | 2 | 3 | 4 | 5 | 6 |
|---|---|---|---|---|---|---|---|
| Wake | 1 | X | | | | | |
| Trigger | 2 | | X | | X | | |
| | 3 | | X | X | X | | |
| | 4 | X | X | X | X | X | X |
| | 5 | | X | | | | |
| | 6 | | | | | | |

Each of the ports shown in Table 1 (or wake domains of the switch) may be in one of a plurality of states. In a high-power state, a port may be “awake”, and may be fully operational to route signal traffic. In a low-power state, the port may be “asleep”, and may not be operational to detect or route signal traffic (e.g., the port and associated hardware may be powered-off). In some embodiments, the port may be in an intermediate state, such as a “trigger” state, in which the port may not be fully operational to route signal traffic, but may be sufficiently operational to detect energy (e.g., a signal) on the port, and register the detected energy as a wake trigger (e.g., the port itself may be at least partially operational, but associated hardware, such as a MAC module and/or switching fabric, may be powered-off).

As shown in Table 1, when energy is detected on port 1, the switch wakes port 1 (places port 1 in a high-power state), e.g., if port 1 detects the energy while in a trigger state. If port 1 is already in a high-power state, then no action is taken. Port 1 may then be used to route signal traffic. If other ports are also in a high-power state, then port 1 may subsequently be used to route signal traffic to/from such other ports.

Similarly, when energy is detected on port 2, the switch wakes port 2 and port 4, if either port is not already in a high-energy state. When energy is detected on port 3, the switch wakes ports 2-4. When energy is detected on port 4, the switch wakes all six ports. When energy is detected on port 5, the switch wakes only port 2. Thus, if port 5 is in a trigger state, it will remain in the trigger state, rather than transitioning to a high-power state. When energy is detected on port 6, no action is taken.

In an example use case of a system configured according to Table 1, port 1 and port 2 may initially be in the high-power state, and ports 3-6 may be in the low-power state. Accordingly, signal traffic may be received at port 1 and routed out port 2 without changing the state of the switch. If more ports are needed to handle additional signal routing (e.g., as traffic is received from other nodes), a signal may be provided to port 2, causing the switch to wake port 4. If yet more ports are needed, a signal may be provided to port 4, causing the switch to wake all ports. Thus, the switch may be operated using only a desired number of ports, while saving power by maintaining other ports in a low-power or intermediate-power state.

A wake map, such as that shown in Table 1, may be stored, e.g., in the management and configuration circuitry 350 of the switch 300, and may be dynamically configurable, e.g., during ongoing operations of the switch 300. For example, the wake map may be user configurable, or may be configurable by a processor, such as a CPU (internal or external to the switch), e.g., based upon operational constraints or application programming. Thus, in some scenarios, the management and configuration circuitry 350 (or other component) may dynamically specify one or more ports to trigger the awakening of other ports (e.g., other wake domains). In other scenarios, the wake map may be configured once at system installation, e.g., based on routing of cables to the ports of the switch. By using a wake map, the first set of ports that come up can determine, based on user-set rules, self-defined rules, or network traffic, if other ports are to be awakened.

In some scenarios, wake domains may be prioritized, and may be awakened in priority order. For example, referring to the switch 300 as illustrated in FIG. 3, in some scenarios domain-1 may be a highest-priority domain, domain-2 may be a medium-priority domain, and domain-3 may be a lowest-priority domain. When the switch 300 is awakened from a low-power state to a high-power state (e.g., by a processor command), the switch 300 may first wake domain-1; e.g., the switch 300 may configure power gates and/or clock gates to provide power and clock signals to hardware of domain-1, and/or may load portions of a switching table that define routing between the ports included in domain-1. Once domain-1 is in the high-power state, the switch may wake domain-2, e.g., by providing power and clock signals to the hardware of domain-2 and/or by loading remaining portions of the switching table that define routing between the ports included in domain-2, as well as between the ports of domain-1 and those of domain-2. Once domain-2 is in the high-power state, the switch may similarly wake domain-3. In some scenarios, lower-priority domains may not be awakened automatically following the awakening of higher-priority domains, but may instead be awakened at a later point in response to additional input or instructions.

Awakening a switch by wake domains, according to a predefined priority order, may provide a further compromise between power cost and wake delay. Specifically, even in scenarios in which all ports of the switch are transitioned from a low-power state to a high-power state, a subset of the ports (those in a high-priority wake domain) may be transitioned to the high-power state quickly, and may begin operation before the remaining ports have transitioned to the high-power state. Thus, ports connected to devices benefitting from faster response times may be configured to be included in the highest-priority domain, while ports connected to devices with lesser time constraints may be configured to be included in a lower-priority domain. This may allow for the switch (or parts thereof) to be placed in a low-power state more frequently (thus saving power), as ports having critical response-time constraints may be returned to a high-power state within such response-time constraints, whereas with a traditional single wake domain switch, critical response-time constraints may dictate that the entire switch remain active.

In some embodiments, the ports included in each wake domain may be dynamically configurable, e.g., user configurable or configurable by a processor, such as a CPU (internal or external to the switch), e.g., based upon operational constraints or application programming. For example, if the switch is included in a home-automation network, the switch may be configured to include in a first domain ports connected to devices that are likely to be used when a user is present in the home. In some scenarios, the first domain may remain in a high-power state as long as the home-automation network determines the user to be present in the home, but may enter a sleep state when the home-automation network detects that the user has departed the home. If a new device is connected to a port of the server, the switch may be reconfigured to include that port in the first domain, if appropriate. Other domains may transition to a high-power or low-power state at other times. Alternatively, the switch may be configured to treat the first domain as a high-priority domain, which may transition quickly from a low-power state to a high-power state, as discussed above, and which may therefore transition to the low-power state even while the user is present in the home. In some such scenarios, the switch may configure the first domain to include the ports connected to devices that are likely to be used when the user is present at home in response to the home-automation network determining the user to be present in the home. The switch may dynamically reconfigure the first domain to not include those ports in response to the home-automation network determining the user to not be present in the home.

In some scenarios, a port may be included in more than one wake domain, e.g., in both the first domain and a second domain, in which case the port may be placed in a high-power state whenever the first domain or the second domain is in the high-power state. The wake domains may be evenly balanced, e.g., as shown in FIG. 3, where each of the three domains includes two ports, or the wake domains may be imbalanced according to current user preference or operational constraints. In some scenarios, a wake domain may be configured to include all or none of the ports of the switch. Configuration settings defining the ports included in each wake domain may be stored within the management and configuration circuitry 350, e.g., as a table stored within a memory of the management and configuration circuitry 350. In some embodiments, reconfiguring which ports are included in each wake domain may include changing the values stored in such a table.

Similarly, priority levels of the wake domains may be dynamically configurable, e.g., user configurable or configurable by a processor, such as a CPU (internal or external to the switch), e.g., based upon operational constraints or application programming. Configuration settings defining the priority levels of the wake domains may be stored within the management and configuration circuitry 350, e.g., as a table stored within a memory of the management and configuration circuitry 350. In some embodiments, reconfiguring the priority levels of the wake domains may include changing the values stored in such a table. As an example use case, in a home-automation network, a first wake domain may include ports connected to devices capable of controlling aspects of a home entertainment system. For example, a first port within the first wake domain may be connected to a controller capable of controlling audio volume output from a speaker. To save power, the switch (or a portion thereof) may be configured to enter a low-power state, e.g., in response to a threshold period of inactivity. The switch may be further configured to wake the first wake domain in response to receiving signal traffic for a device connected to one of the ports included in the first domain (e.g., signal traffic directed to the controller, the signal traffic including a volume control command). While the entertainment system is powered on, the user experience may be diminished by a delayed response to a volume control command, or other such media control commands. Therefore, while the entertainment system is powered on, the switch may be configured such that the first wake domain has a high priority, such that it may be awakened with minimal delay, e.g., in response to the received signal traffic. However, when the entertainment system is powered off, the user experience may not be significantly impacted by a larger delay in communications to the controller or other media control device, and the switch may therefore be configured such that the first wake domain has a low priority.

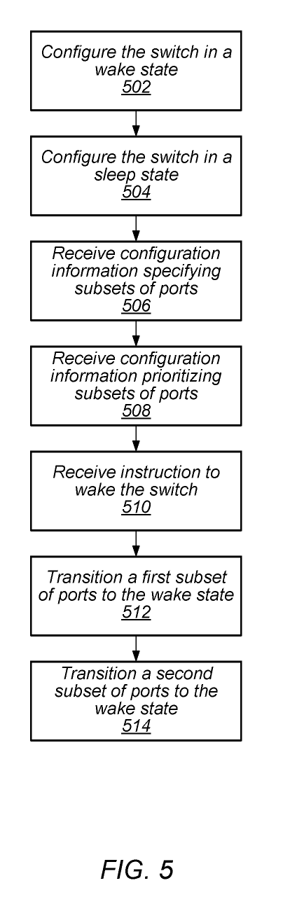

### FIGS. 4-5—Methods of Operating a Network Switch

FIG. 4 is a flow chart illustrating a first example method of operating a network switch having a plurality of ports, according to some embodiments. The operations of FIG. 4 may be performed by a multiple wake domain network switch, such as the switch 300.

At 402, the switch 300 may be configured such that the plurality of ports of the switch 300 is in a wake state. The wake state may be a high-power state, as discussed above with regard to FIG. 3. For example, a port in the wake state may be configured to transmit and/or receive signal traffic. Following 402, the switch may be in a fully operational state, in which all ports are in the wake state. For example, all ports, as well as signal processing chains, switch fabric, and other associated components may be powered on and configured for operation. In other embodiments, the switch 300 may include other ports (in addition to the recited plurality of ports), which may or may not be in the wake state.

At 404, the switch 300 may be configured such that the plurality of ports is in a sleep state. The sleep state may be a low-power state or an intermediate-power state (e.g., a trigger state), as discussed above with regard to FIG. 3. For example, a port in the sleep state may not be configured to transmit or receive signal traffic. Operation 404 may be performed, e.g., in response to a received instruction or automatically, such as in response to inactivity on the plurality of ports for a threshold period of time following configuring the network switch in the wake state at 402. Following 404, the switch may be in a non-operational state, in which all ports are in a sleep state. For example, all ports and/or associated components may be powered off, unclocked, and/or unconfigured. In some embodiments, a switching table of the switch fabric may not be loaded, e.g., in a memory of the switch fabric. In other embodiments, the switch 300 may include other ports (in addition to the recited plurality of ports), which may or may not be in the sleep state.

At 406, the switch 300 may receive configuration information specifying subsets of the plurality of ports. For example, the configuration information of operation 406 may specify ports to be included in a first subset of ports and ports to be included in a second subset of ports. Additional subsets may also be specified. It should be appreciated that, in some embodiments, such configuration information may be received at a different point in the method. For example, the configuration information may be received before operation 402 and/or operation 404, or may be received at a later time. In some scenarios, configuration information specifying subsets of the plurality of ports may be received at multiple points in the method, such that the ports included in the subsets may change throughout operation of the switch 300.

At 408, the switch 300 may transition the first subset of the plurality of ports to the wake state while the second subset of the plurality of ports remains in the sleep state. Transitioning the first subset of the plurality of ports to the wake state may include providing power and/or clock signals (e.g., by configuring one or more power gates and/or clock gates) to the first subset of ports, to their respective signal processing chains, and/or to other associated components, such as buffers and at least a portion of the switch fabric. Power and/or clock signals may not be provided to the second subset of ports. Transitioning the first subset of the plurality of ports to the wake state may additionally, or alternatively, include configuring a first portion of the switch fabric of the network switch. The first portion of the switch fabric may provide routing between the first subset of the plurality of ports, and may not provide routing between the second subset of the plurality of ports. Other means of transitioning the first subset of the plurality of ports to the wake state may also be used, e.g., as described above with regard to FIG. 3.

At 410, the switch 300 may receive configuration information specifying a first port of the first subset of the plurality of ports as a trigger port for waking the second subset of the plurality of the ports. For example, the switch 300 may receive configuration information defining a wake map, such as Table 1, as discussed above, the wake map specifying that the second subset of ports is to transition to the wake state in response to detecting energy on the first port. Alternatively, the configuration information may be received in other format, such as a list, table, etc. specifying configuration details (e.g., trigger port assignments) for one or more ports including the first port. It should be appreciated that the configuration information of operation 410 may be received at any point in the method. For example, the configuration information may be received at any point following, or concurrent with, receipt of the configuration information specifying the subsets of the plurality of ports (e.g., at 406).

At 412, the switch 300 may detect energy on the first port, while the first port is in the wake state. At operation 414, the switch 300 may transition the second subset of the plurality of ports to the wake state, e.g., in response to detecting the energy on the first port and determining that first port has been specified as the trigger port.

Following operation 414, the switch 300 may return to any previous operation of the method, or otherwise continue operation, e.g., in response to signal traffic, application programming, and/or received instructions.

It should be understood that various operations of the method illustrated in FIG. 4 may be performed concurrently, in a different order than shown, or omitted, and other operations may be added. For example, some embodiments of the method may exclude various combinations of operations 402, 406, 410, and/or 412. Some embodiments may further exclude one of operations 408 (e.g., where the sleep state is a trigger state) or 414.

FIG. 5 is a flow chart illustrating a second example method of operating a network switch having a plurality of ports, according to some embodiments. The operations of FIG. 5 may be performed by a multiple wake domain network switch, such as the switch 300.

Operations 502, 504, and 506 may be similar to operations 402, 404, and 406, respectively.

At 508, the switch 300 may receive configuration information prioritizing one or more subsets of ports. For example, the configuration information may specify that the first subset of the plurality of ports is a high-priority subset, e.g., a higher-priority subset than the second subset of the plurality of ports, or vice versa. In some implementations, each subset can be assigned a default priority, which can then be modified through prioritization.

At 510, the switch 300 may receive an instruction to wake the switch 300—e.g., to transition some or all of the plurality of ports to the wake state. The instruction may be received, e.g., as energy detected on a port, or as an instruction received from another outside source. In some scenarios, the instruction may expressly indicate that the switch 300 is to wake by subset.

At 512, the switch 300 may transition the first subset of the plurality of ports from the sleep state to the wake state while the second subset of the plurality of ports remains in the sleep state. Operation 512 may be performed in response to receiving the instruction to wake the switch 300, and further in response to determining that the first subset of the plurality of ports has a higher priority than the second subset (e.g., in response to determining that the first subset has the highest priority of the subsets currently in the sleep state), e.g., as defined by the configuration information received at 508. The first subset of the plurality of ports may transition to the wake state in a manner similar to operation 408, as described with regard to FIG. 4.

At 514, the switch 300 may transition the second subset of the plurality of ports from the sleep state to a wake state, e.g., automatically, in response to determining that the first plurality of ports has completed transitioning from the sleep state to the wake state and/or in response to determining that the second subset of the plurality of ports has the highest priority of the subsets currently in the sleep state. Any additional subsets of the plurality of ports may similarly transition to the wake state in sequence, or in parallel, based on their relative priority, e.g., as defined by the configuration information received at 508.

It should be understood that various operations of the method illustrated in FIG. 5 may be performed concurrently, in a different order than shown, or omitted, and other operations may be added. For example, some embodiments of the method may exclude various combinations of operations 502, 506, 508, and/or 510. Some embodiments may further exclude one of operations 512 or 514.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a switch) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A network switch comprising:
a plurality of ports;
a first wake domain comprising a first subset of the plurality of ports and a first portion of a switch fabric; and
a second wake domain, different from the first wake domain, comprising a second subset of the plurality of ports and a second portion of the switch fabric;
wherein the first wake domain and the second wake domain are configured to independently transition between a low-power state and a high-power state.

2. The network switch of claim 1, further comprising:
management circuitry configured to dynamically add one or more ports of the plurality of ports to either the first subset of the plurality of ports or the second subset of the plurality of ports, and to dynamically remove one or more ports from either the first subset of the plurality of ports or the second subset of the plurality of ports.

3. The network switch of claim 1, further comprising:
at least one power gate configured to selectively block power to at least a portion of the first wake domain to cause the first wake domain to transition to the low-power state.

4. The network switch of claim 3, further comprising:
at least one power gate configured to selectively block power to at least a portion of the second wake domain to cause the second wake domain to transition to the low-power state, wherein the selectively blocking power to at least a portion of the second wake domain is independent of the selectively blocking power to at least a portion of the first wake domain.

5. The network switch of claim 1,
wherein the first wake domain is configured to transition from the high-power state to the low-power state at least in part by blocking power to the first set of ports.

6. The network switch of claim 1,
wherein the first portion of the switch fabric comprises a first set of buffers associated with the first set of ports; and
wherein the first wake domain is configured to transition from the high-power state to the low-power state at least in part by blocking power to the first set of buffers.

7. The network switch of claim 1,
wherein the switch fabric comprises a memory;
wherein the first wake domain is configured to transition from the low-power state to the high-power state at least in part by saving to the memory a first portion of a switching table, the first portion of the switching table defining routing between the first subset of ports; and
wherein the first portion of the switching table does not define routing between the first subset of ports and other ports of the network switch that are in the low-power state.

8. The network switch of claim 7,
wherein the first portion of the switching table further defines routing between the first subset of ports and at least one other port of the network switch that is in the high-power state.

9. The network switch of claim 1, further comprising:
a third wake domain comprising a third subset of the plurality of ports and a third portion of the switch fabric;
wherein the third wake domain is configured to transition between a low-power state and a high-power state independently of the first wake domain and the second wake domain.

10. The network switch of claim 1,
wherein the second wake domain is configured to transition from the low-power state to the high-power state at least in part in response to the network switch detecting energy on a specified port of the first wake domain while the first wake domain is in the high-power state.

11. The network switch of claim 10, further comprising:
management circuitry configured to dynamically specify the specified port of the first wake domain.

12. A method of operating a network switch having a plurality of ports, the method comprising:
configuring the network switch such that the plurality of ports is in a sleep state, wherein a port in the sleep state is not configured to transmit signal traffic or receive signal traffic; and
transitioning a first subset of the plurality of ports from the sleep state to a wake state while a second subset of the plurality of ports remains in the sleep state, wherein a port in the wake state is configured to perform at least one of transmitting signal traffic or receiving signal traffic.

13. The method of claim 12, further comprising:
configuring the network switch such that the plurality of ports is in the wake state;
wherein the configuring the network switch such that the plurality of ports is in the sleep state is at least partly in response to inactivity on the plurality of ports for a threshold period of time following the configuring the network switch such that the plurality of ports is in the wake state.

14. The method of claim 12, further comprising:
detecting energy at a first port of the first subset of the plurality of ports while the first subset of the plurality of ports is in the wake state; and
transitioning, in response to detecting the energy at the first port, the second subset of the plurality of ports from the sleep state to the wake state.

15. The method of claim 14, further comprising:
receiving configuration information specifying the first port as a trigger port for waking the second subset of the plurality of the ports;
wherein transitioning the second subset of the plurality of ports from the sleep state to the wake state is further in response to determining that the first port has been specified as the trigger port.

16. The method of claim 12, further comprising:
automatically transitioning the second subset of the plurality of ports from the sleep state to a wake state in response to determining that the first plurality of ports has completed transitioning from the sleep state to the wake state.

17. The method of claim 16, further comprising:
receiving configuration information specifying that the first subset of the plurality of ports is a higher-priority subset than the second subset of the plurality of ports; and
receiving an instruction to wake the network switch;
wherein transitioning the first subset of the plurality of ports from the sleep state to a wake state, while a second subset of the plurality of ports remains in the sleep state, is in response to receiving the instruction to wake the network switch and is further in response to determining that the first subset of the plurality of ports is a higher-priority subset than the second subset of the plurality of ports.

18. The method of claim 12, further comprising:
receiving configuration information specifying ports to be included in the first subset of the plurality of ports.

19. The method of claim 12, wherein transitioning the first subset of the plurality of ports from the sleep state to the wake state while the second subset of the plurality of ports remains in the sleep state comprises at least one of:
configuring at least one power gate to provide power to the first subset of the plurality of ports without providing power to the second subset of the plurality of ports; or
configuring a first portion of a switch fabric of the network switch, the first portion of the switch fabric providing routing between the first subset of the plurality of ports without providing routing between or to the second subset of the plurality of ports.

20. A non-transitory computer-readable memory medium storing software instructions executable by a processor of a network switch having a plurality of ports to cause the network switch to:
transition a first subset of the plurality of ports between a sleep state and a wake state while an independent second subset of the plurality of ports remains in one of the sleep state and the wake state;
wherein a port in the wake state is configured to transmit and/or receive signal traffic; and
wherein a port in the sleep state is not configured to transmit and/or receive signal traffic.
